(19) United States
(12) Patent Application Publication
(10) Pub. No.: US 2010/0079050 A1
(43) Pub. Date: Apr. 1, 2010

(54) Light emitting device and method of manufacturing the same

(76) Inventors: Hitoshi Kamamori, Chiba-shi (JP); Sadao Oku, Chiba-shi (JP); Keiichiro Hayashi, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/586,795

(22) Filed: Sep. 28, 2009

(30) Foreign Application Priority Data
Sep. 29, 2008 (JP) 2008-249484

(51) Int. Cl. H01K 1/30; H01J 9/00

(52) U.S. Cl. 313/113; 445/29

(57) ABSTRACT

A light emitting device includes: a glass package (2) having a recess (5) in its center; a through-hole electrode (4) formed by filling a through hole (3), which is formed at a bottom of the recess (5), with a conductive material; a light emitting diode element (6) received in the recess (5) and mounted on the through-hole electrode (4); an insulating multilayer interference film (7) formed on an inner wall surface and a bottom surface of the recess (5); and a sealing material for sealing the light emitting diode element. With this structure, the light emitting device is improved in reliability.

### BACKGROUND OF THE INVENTION

1. Field of the Invention

The present invention relates to a light emitting device having a structure in which a light emitting element is packaged, and a method of manufacturing the light emitting device.

2. Description of the Related Art

In recent years, a light emitting diode element (hereinafter referred to as LED element) has been improved in luminance and the like, and is put into practical use in a variety of fields. For example, the LED element is used for a backlight of a liquid crystal display apparatus, a light emitting element of a traffic light, an electric bulletin board, and other illumination purposes. The LED element may be operated with low voltage and low power consumption, and has been improved in luminance. Therefore, the LED element is expected to be applied to an indoor light, automobile illumination, and the like.

However, the LED element alone is still weaker in luminance than other light emitters, and hence a large number of the LED elements have to be combined to constitute a light emitter. Also, as the light emitting intensity of the LED element is increased, more heat is generated. When the LED element is heated, the light emitting efficiency is reduced. Accordingly, the LED element needs to have a structure for effectively radiating heat. Further, in order for the LED element to take over another light emitter such as a fluorescent light, its manufacturing process needs to be simplified to reduce the manufacturing cost.

An LED sub-mount, which is formed by assembling a glass substrate and a silicon (Si) wafer, is known to be an inexpensive structure having an excellent heat radiating property. As illustrated in FIG. 10, a glass substrate 51 and an Si wafer 54 having a through hole 58 are bonded together, and LED elements 56A are mounted on a region of the glass substrate 51 corresponding to the through hole 58. Through-hole electrodes 52 are formed in the glass substrate 51 and electrically connected to the LED elements 56A through connection electrode metallizations 53B. Further, the through-hole electrodes 52 are electrically connected to electrode metallizations 53A formed on a back surface of the glass substrate 51. On a side surface of the through hole 58, a reflective surface 55 is formed to reflect light emitted from the LED elements 56A upward. A metallization or a metal is used for the reflective surface 55 (see, for example, JP 2007-42781 A). With this structure, heat generated in the LED elements 56A may be effectively radiated through the through-hole electrodes 52. Also, the glass substrate and the Si substrate are anodic-bonded, and hence the bonding strength may be improved. Further, a large number of LED mounts may be manufactured in a batch, and hence the costs may be reduced.

As illustrated in FIG. 11, there has also been described a light emitting device 61 including a metallic substrate 62 on which a light emitting element 65 is mounted, and a first frame body 63 and a second frame body 64 formed to surround the light emitting element 65. A projecting mounting part 62a is formed in a center part of the metallic substrate 62, and the light emitting element 65 is formed on the projecting upper surface. The first frame body 63 is bonded on a peripheral stepped part of the metallic substrate 62. The first frame body 63 is formed of an insulating material and an electrode is formed therein. The second frame body 64, which is formed of a metal in a shape that surrounds the light emitting element 65, is bonded to an upper surface of the first frame body 63. An inner wall surface of the second frame body 64 has a shape that becomes wider from the bottom toward the top, and reflects light emitted from the light emitting element 65 upward (see, for example, JP 2004-228240 A). With this structure, light emitting efficiency is increased, the heat radiating property is improved, a driving current that is input to the light emitting element 65 may be increased, and light output from the light emitting element is increased.

In the structure of the conventional LED sub-mount illustrated in FIG. 10, the glass substrate 51 including the through-hole electrodes 52, and the Si substrate 54 bonded on the glass substrate 51 are separate members. Therefore, there is a need for the glass substrate 51 and the Si substrate 54 to be processed separately and then bonded together. In the structure of the light emitting device 61 illustrated in FIG. 11, the metallic substrate 62 on which the light emitting element 65 is mounted, the first frame body 63 formed of the insulating material, and the second frame body 64 formed of the metal are separate members. Therefore, there is a need for the three members to be processed separately and then bonded together. In other words, there is a need to bond heterogeneous materials to each other.

However, the LED element generates heat each time the LED element emits light, and hence heat expansion and contraction repeatedly occur. Therefore, there has been a problem in that bonding and sealing properties are reduced in the joint portion. Further, a step of bonding separate members to each other is required after the members are separately processed, which results in increased number of manufacturing steps and increased product costs.

### SUMMARY OF THE INVENTION

In order to solve the above-mentioned problems, a light emitting device according to the present invention has the following structure. Specifically, the light emitting device includes: a glass substrate in which a recess is formed; a through-hole electrode formed by filling a through hole, which is formed at a bottom of the recess, with a conductive material; a light emitting diode element received in the recess and mounted on the through-hole electrode; an insulating reflective film formed on an inner wall surface and a bottom surface of the recess; and a sealing material supplied to the recess to seal the light emitting diode element.

Further, a cold mirror or a multilayer interference film is used for the reflective film. Further, the sealing material includes a material obtained by curing one of metal alkoxide and polymetalloxane formed from metal alkoxide.

Further, the through hole is formed to have a cross-sectional shape that becomes wider from a back surface of the glass substrate toward the bottom of the recess.

A method of manufacturing a light emitting device according to the present invention includes: molding a glass material by a molding method to form a glass substrate having a recess and a hole in a region of the recess; forming a reflective film, which is formed of an insulating material, on a surface of the glass substrate on which the recess is formed; forming a through-hole electrode by providing a conductive material in the hole of the glass substrate; grinding a back surface of the glass substrate to expose the through-hole electrode to the back surface and to planarize an exposed surface of the through-hole electrode and the back surface of the glass substrate; mounting a light emitting diode element on the through-hole electrode exposed at a bottom of the recess of the glass substrate; and supplying a sealing material to the recess to seal the light emitting diode element.

The method of manufacturing a light emitting device further includes, after the grinding, printing a metal paste on the back surface of the glass substrate to form a back surface electrode.

According to the present invention, a reliable light emitting device may be realized with a simple manufacturing method.

### BRIEF DESCRIPTION OF THE DRAWINGS

In the accompanying drawings:

FIGS. 1A and 1B are schematic diagrams for describing a light emitting device according to the present invention;

FIGS. 2A and 2B are cross-sectional diagrams schematically illustrating a method of manufacturing a light emitting device according to the present invention;

FIG. 3 is a cross-sectional diagram schematically illustrating the method of manufacturing a light emitting device according to the present invention;

FIG. 4 is a cross-sectional diagram schematically illustrating the method of manufacturing a light emitting device according to the present invention;

FIG. 5 is a cross-sectional diagram schematically illustrating the method of manufacturing a light emitting device according to the present invention;

FIG. 6 is a cross-sectional diagram schematically illustrating the method of manufacturing a light emitting device according to the present invention;

FIG. 7 is a cross-sectional diagram schematically illustrating the method of manufacturing a light emitting device according to the present invention;

FIG. 8 is a cross-sectional diagram schematically illustrating the method of manufacturing a light emitting device according to the present invention;

FIG. 9 is a cross-sectional diagram schematically illustrating the method of manufacturing a light emitting device according to the present invention;

FIG. 10 is a cross-sectional schematic diagram illustrating a light emitting device according to the related art; and

FIG. 11 is a cross-sectional schematic diagram illustrating another light emitting device according to the related art.

### DETAILED DESCRIPTION OF THE PREFERRED EMBODIMENTS

A light emitting device according to the present invention includes a glass substrate in which a recess is formed, and an insulating reflective film is formed on an inner wall surface and a bottom surface of the recess. Further, a through hole is formed at the bottom of the recess, and a through-hole electrode formed of a conductive material is formed in the through hole. A light emitting diode element is mounted on the through-hole electrode. The light emitting diode element is received in the recess of the glass substrate and sealed by a sealing material supplied to the recess. The glass substrate is integrally formed of a glass material and has no bonding surface. Therefore, even when expansion and contraction are repeated due to heat generated in the light emitting diode element, moisture and foreign substances hardly enter from the outside. This suppresses corrosion of the electrode material and deterioration of characteristics of the light emitting diode element to improve reliability. Further, with the substrate of a package being formed of a single member, a number of manufacturing steps may be reduced, and a reliable light emitting device may be provided with reduced costs.

In this case, in order to suppress heat generation of the light emitting device, a cold mirror is suitably used for the reflective film. The cold mirror is a reflective film having a characteristic that reflects visible light and transmits light in the infrared region. A multilayer interference film may be used as the reflective film. A material obtained by curing metal alkoxide or polymetalloxane formed from metal alkoxide is suitably used as the sealing material.

Further, the through hole is formed to have a cross-sectional shape that becomes wider from a back surface of the glass substrate toward the bottom of the recess. In other words, the hole is larger on the recess side than on the bottom surface side of the glass substrate. In this way, the conductive material filled in the through hole may be prevented from slipping out from the back surface of the glass substrate.

A method of manufacturing a light emitting device according to the present invention includes: molding a glass material by a molding method to form a glass substrate having a recess and a hole in a region of the recess; forming a reflective film, which is formed of an insulating material, on a surface of the glass substrate on which the recess is formed; forming a through-hole electrode by providing a conductive material in the hole of the glass substrate; grinding a back surface of the glass substrate to expose the through-hole electrode to the back surface and to planarize an exposed surface of the through-hole electrode and the back surface of the glass substrate; mounting a light emitting diode element on the through-hole electrode exposed at a bottom of the recess of the glass substrate; and supplying a sealing material to the recess to seal the light emitting diode element.

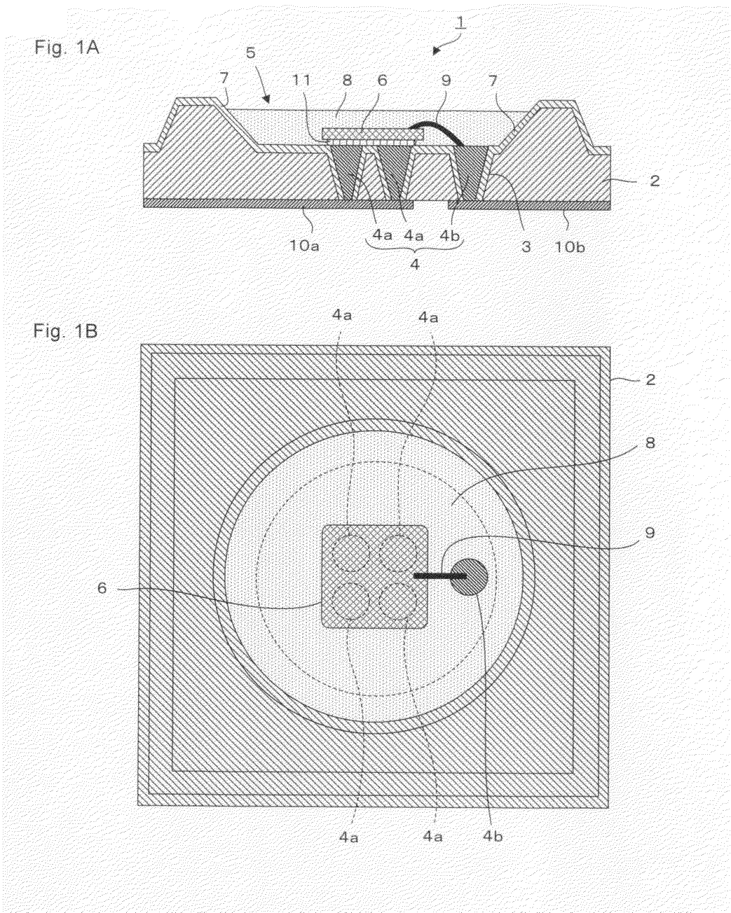

FIGS. 1A and 1B are schematic diagrams for describing a light emitting device 1 according to an embodiment of the present invention. FIG. 1A schematically illustrates a cross-sectional structure of the light emitting device 1, and FIG. 1B is a schematic top view of the light emitting device 1. The light emitting device 1 includes a glass package 2 in which through holes 3 are formed, an LED element 6, and a sealing material 8 filled in a recess 5. A multilayer interference film 7 formed of an insulating material is formed on a top surface of the glass package 2, and back surface electrodes 10a and 10b (collectively referred to by reference numeral 10) are formed on a back surface of the glass package 2. Further, through-hole electrodes 4a and 4b (collectively referred to by reference numeral 4) are filled in the through holes 3, and the LED element 6 is arranged above four through-hole electrodes 4a through a die bonding material 11 to be electrically connected to the through-hole electrode 4b through a wire 9.

The recess 5 is formed in a center part of the glass package 2, and a plurality of the through holes 3 are formed at the bottom of the recess 5. The through holes 3 are each formed to have a cross-sectional shape that becomes wider from a back surface of the glass package 2 toward the bottom of the recess 5. The multilayer interference film 7 is formed of an insulating material, and formed also on an inner wall surface and a bottom surface of the recess 5. The LED element 6 includes electrodes (not shown) formed on an upper surface and a lower surface thereof. The lower surface electrode of the LED element 6 is fixed to the bottom of the recess 5 of the glass package 2 through the die bonding material 11 and electrically connected to the through-hole electrodes 4a. The upper surface electrode of the LED element 6 is electrically connected to the through-hole electrode 4b through the wire 9. In other words, the LED element 6 may be supplied with power from the back surface electrodes 10a and 10b, which are separately formed on the back surface of the glass package 2.

The glass package 2 may be formed from a standard glass material containing silicon oxide as a main component. The recess 5 and the through holes 3 formed in the glass package 2 may be formed at the same time by molding the glass material as described below. Therefore, as opposed to the related art, there is no need for the substrate and the frame bodies to be individually processed and then bonded together. In other words, the substrate part of the present invention is not formed by a plurality of different materials and has no bonding surface for bonding those members. As a result, deterioration at the bonding surface does not occur, and reliability may be improved. Further, the number of manufacturing steps is reduced, and hence the manufacturing costs may be reduced.

The insulating multilayer interference film 7 is formed on the entire front surface of the glass package 2 as a reflective surface that reflects light emitted from the LED element 6. With its insulating property, the multilayer interference film 7 does not short-circuit the through-hole electrodes 4a and 4b even when the multilayer interference film 7 is formed on the side surface of the through holes 3 and the bottom surface of the recess 5. Therefore, the multilayer interference film 7 deposited on the bottom of the recess 5 does not need to be removed by patterning or etching, and the manufacturing becomes easier. Further, the multilayer interference film 7 may be formed by sputtering or vapor-depositing a metal oxide. For example, a film formed of SiO, SiO₂, TiO₂, ZrO₂, CeO₂, Al₂O₃, or other such metal oxides may be used. With the glass package 2 containing silicon oxide as a main component, when a silicon oxide film is formed as the multilayer interference film on the glass package 2, the adhesion of the film may be improved. Being an oxide, the multilayer interference film 7 hardly corrodes. Therefore, a reliable reflective surface may be formed.

The through holes 3 are formed in the glass package 2. The through holes 3 are filled with a conductive paste containing silver (Ag), or with a metal material such as nickel (Ni), iron (Fe), copper (Cu), kovar, or the like, and then the filled material is heated and solidified to form the through-hole electrodes 4a and 4b. The through-hole electrodes 4a and 4b may also be formed by inserting a metal core to be bonded and fixed to the through holes 3, or by filling molten solder to be cooled and solidified. The through-hole electrodes 4a and 4b each have a cross-sectional shape that is the same as the cross-sectional shape of each of the through holes 3 formed in the glass package 2 and that becomes wider from the back surface of the glass package 2 toward the bottom of the recess 5. Therefore, the through-hole electrodes 4a and 4b hardly slip out from the bottom side of the recess 5 toward the back surface side of the glass package.

The back surface electrodes 10 are formed on the back surface of the glass package 2. The back surface electrodes 10 are formed by planarizing the back surface of the glass package 2 by grinding, and forming a conductive film on the planarized back surface. The conductive film may be formed by vapor depositing or printing. When printing is used, the manufacturing process becomes easier.

The LED element 6 is mounted above the through-hole electrodes 4 through the die bonding material 11. The die bonding material 11 includes a bump or a conductive adhesive to bond and fix the LED element 6 to the bottom of the recess 5. An electrode (not shown) is formed on the back surface of the LED element 6 and electrically connected to the through-hole electrodes 4a through the die bonding material 11. Another electrode (not shown) is formed on the front surface of the LED element 6 and electrically connected to the through-hole electrode 4b through the wire 9.

As described above, with the LED element 6 being connected to the back surface electrodes 10 through the through-hole electrodes 4a and the conductive die bonding material, heat generated in the LED element 6 is radiated through the die bonding material 11, the through-hole electrodes 4a, and the back surface electrode 10a. The heat generated in the LED element 6 is also radiated through the wire 9, which is formed of gold (Au) or the like, the through-hole electrode 4b, and the back surface electrode 10b. Accordingly, an increase in temperature of the LED element 6 may be suppressed.

The sealing material 8 is filled in the recess 5 of the glass package 2 and covers the LED element 6 and the wire 9. The sealing material 8 prevents foreign substances, moisture, and the like from entering from the outside, and hence prevents the electrode material and the like from corroding. A metal oxide obtained by polymerizing and calcining metal alkoxide or polymetalloxane formed from metal alkoxide may be used as the sealing material 8. For example, silicon oxide, aluminum oxide, titanium oxide, and zirconia oxide may be given as examples. The oxide obtained by polymerizing and calcining metal alkoxide or polymetalloxane formed from metal alkoxide exhibits excellent adhesion with respect to glass. Especially, when silicon oxide formed from metal alkoxide or polymetalloxane is used as the sealing material 8, with the glass package 2 being also formed of silicon oxide, their thermal expansion coefficients become close to each other and a good bonding property is obtained. When a silicon oxide film is used as a film on the surface of the multilayer interference film 7, adhesion is further improved. Accordingly, deterioration due to heat expansion and contraction may be reduced, and a reliable light emitting device may be obtained.

It should be noted that, as illustrated in FIG. 1B, the light emitting device in this embodiment includes four through-hole electrodes 4a, which are connected to the lower surface electrode of the LED element 6 through the die bonding material 11, and one through-hole electrode 4b, which is connected to the upper surface electrode of the LED element 6 through the wire 9. The through-hole electrodes 4a and 4b have the same shape. However, the present invention is not limited to the above-mentioned structure, and a larger number of the through-hole electrodes 4a or one through-hole electrode 4a may be formed under the LED element 6. Also, a contour of the through-hole electrode 4b, which is connected through the wire 9, may be larger than a contour of each of the other through-hole electrodes 4a. Further, a plurality of the LED elements 6 may be formed inside the recess 5 of the glass package 2. With this structure, light intensity may be further increased. Further, a contour shape of the light emitting device 1 may be a hexagon or higher polygon or a circle. The light emitting device 1 desirably has a contour shape that allows dense arrangement so that a large number of the light emitting devices 1 may be formed at the same time on a large board.

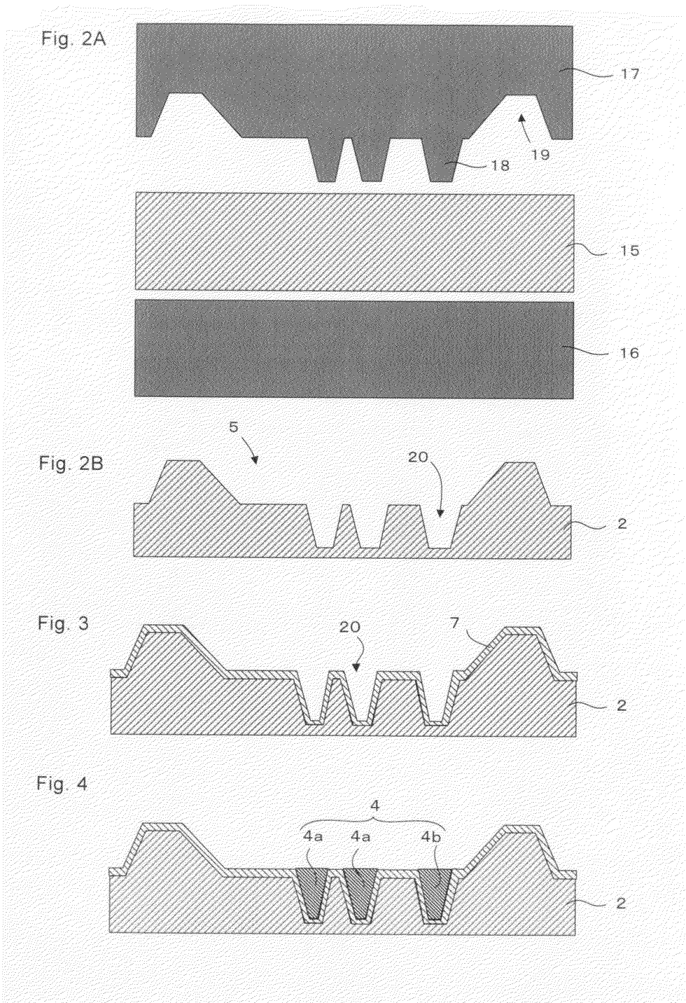

Referring to FIGS. 2A to 9, a method of manufacturing a light emitting device 1 according to another embodiment of the present invention is described below. FIG. 2A schematically illustrates a state where a glass material is molded by mold pressing. FIG. 2B is a cross-sectional schematic diagram of a glass package 2 formed by mold pressing. As illustrated in FIG. 2A, projections and depressions are formed on a surface of a mold 17. A glass material 15 is heated to its softening point or higher and placed on a platen 16. Then, the mold 17 is lowered to press the glass material 15. With this operation, shapes of the projections and depressions of the mold 17 are transferred to the glass material 15. After cooling, the mold 17 is raised, and the glass material 15, to which the projections and depressions have been transferred, is removed from the platen 16. As illustrated in FIG. 2B, a recess 5 and holes 20 for forming through holes 3 at the bottom of the recess 5 are formed in the removed glass material 15, which becomes a glass package 2.

The projections and depressions of the mold 17 are tapered. Therefore, tips of projections 18 are thinner and bottoms of depressions 19 are narrower. The tapers improve releasability of the mold 17 with respect to the glass material 15. Also, the holes 20 of the glass package 2, which are formed by transferring the projections 18 of the mold 17, become wider from the bottom toward the top. Accordingly, an advantage is also obtained in that, when through-hole electrodes 4 are filled in the holes 20 later, the through-hole electrodes 4 hardly slip out from the holes 20. Further, the tapered surface of each of the depressions 19 is used as a reflection surface for reflecting light emitted from an LED element 6.

In this embodiment, when the glass package 2 is molded, the holes 20 for forming the through-hole electrodes 4 do not pierce the glass package 2. This prevents a conductive paste from leaking to the back surface side when the conductive paste is filled later in the holes 20 to form the through-hole electrodes 4. However, the problem of leakage does not occur depending on the material and characteristics of the through-hole electrodes 4. In that case, the holes 20 may pierce the glass package 2 when the glass material 15 is molded, or after the glass material 15 is molded and before the through-hole electrodes 4 are formed.

Subsequently, a multilayer interference film 7 formed of an insulating material is formed on a top surface of the glass package 2. FIG. 3 schematically illustrates this state in cross section. The multilayer interference film 7 is formed by depositing the insulating material including a metal oxide and a fluoride by sputtering or vapor deposition. For example, SiO, SiO₂, TiO₂, ZrO₂, CeO₂, Al₂O₃, Fe₂O₃, or the like may be used as the metal oxide, and a few layers or a few tens of layers of the metal oxide are laminated to form the multilayer interference film 7. With the multilayer interference film 7 being formed of the insulating material, there is no need to remove the multilayer interference film 7 deposited on the bottom of the recess 5. Therefore, a step of patterning the multilayer interference film 7 is not required.

Subsequently, the conductive paste containing a metal such as Ag is filed in the holes 20 illustrated in FIG. 3 by a dispenser or the like. The filled conductive paste is heated and solidified to form the through-hole electrodes 4. FIG. 4 illustrates a state where the through-hole electrodes 4 are formed in the holes 20 of the glass package 2. Instead of the conductive paste, a metal core may be inserted to be bonded and fixed to the holes 20.

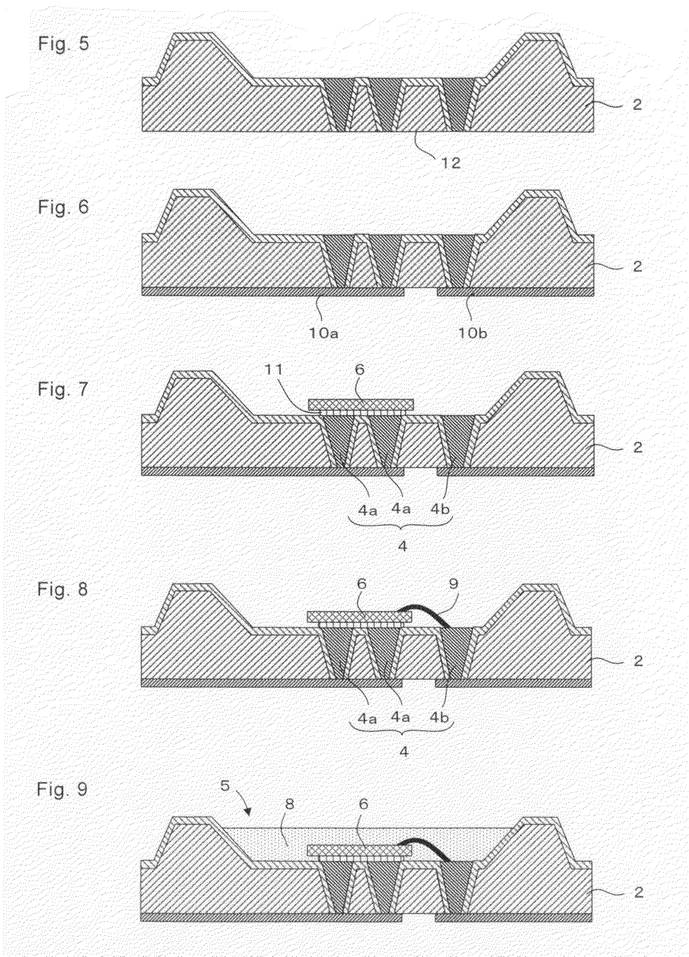

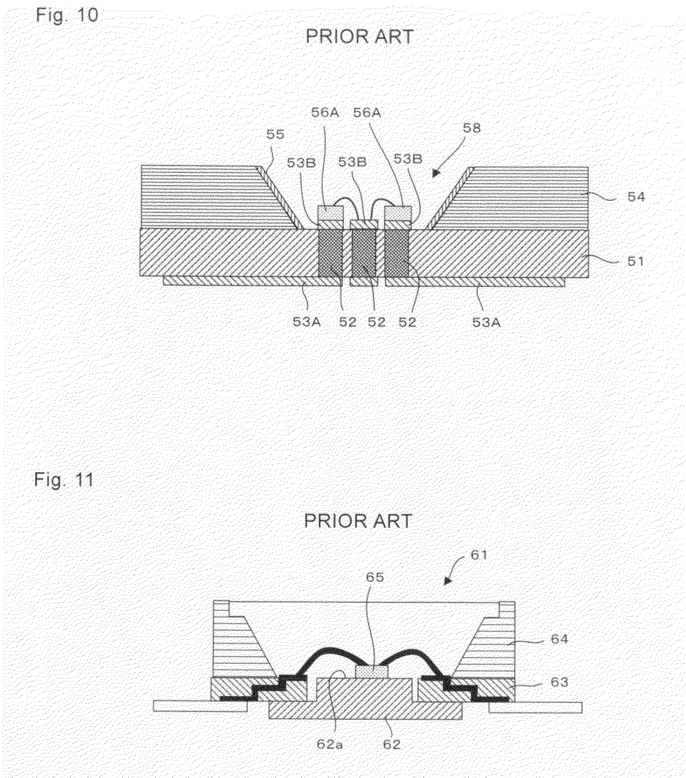

Subsequently, the back surface of the glass package 2 is ground to expose the through-hole electrodes 4 to the back surface. The glass package 2 is placed on a grinding platen or grinding pad with a flat surface, and is pressed against and moved relative to the grinding platen or grinding pad to be ground. This way, the exposed portion of the through-hole electrodes 4 and a back surface 12 of the glass package 2 may be planarized. FIG. 5 schematically illustrates this state.

Subsequently, a back surface electrode 10a to be connected to the through-hole electrodes 4a and a back surface electrode 10b to be connected to the through-hole electrode 4b are formed on the back surface of the glass package 2. FIG. 6 schematically illustrates this state. Ink containing a conductive material such as Ag is printed on the back surface of the glass package 2 by screen printing. Then, the printed ink is calcined by heating to be solidified. Forming the back surface electrodes 10 by printing eliminates the need for a photolithography step and an etching step, and hence manufacturing costs may be reduced. Further, with the back surface of the glass package 2 being flat, the light emitting device 1 may be easily mounted to another substrate.

FIG. 7 is a cross-sectional schematic diagram illustrating a state where the LED element 6 is mounted on the through-hole electrodes 4. An electrode is formed on a back surface of the LED element 6. The LED element 6 is placed above the through-hole electrodes 4 through a die bonding material 11. The LED element 6 is heated and pressed to be bonded to the glass package 2 and the through-hole electrodes 4. A solder bump or a gold bump may be used as the die bonding material 11. Alternatively, a conductive adhesive may be used as the die bonding material 11.

FIG. 8 is a cross-sectional schematic diagram illustrating a state where an electrode formed on an upper surface of the LED element 6 and the through-hole electrode 4b are connected by a wire 9. A gold wire may be used as the wire 9.

FIG. 9 is a cross-sectional schematic diagram illustrating a state where a sealing material 8 is filled in the recess 5 of the glass package 2. The sealing material 8 is silicon oxide obtained by curing metal alkoxide or polymetalloxane formed from metal alkoxide. Specifically, a metal alkoxide solution is filled in the recess 5 of the glass package 2 by using a dispenser or the like. For example, a mixture of nSi (OCH₃)₄, 4nH₂O, a catalyst (NH₄OH), and an anti-crack agent (dimethylformamide: DMF) may be used as the metal alkoxide solution. The solution is hydrolyzed and polymerized at a temperature range from room temperature to about 60° C. to form a polymetalloxane sol. Further, the sol is polymerized at a temperature range from room temperature to 60° C. to form a wet silicon oxide gel, and the gel is dried and calcined at a temperature of about 100° C. or higher to form silicon oxide. Alternatively, silicon oxide may be formed by filling polymetalloxane in the recess 5 of the glass package 2 and by polymerizing and calcining the filled polymetalloxane as described above.

The silicon oxide obtained by polymerizing and calcining metal alkoxide or polymetalloxane formed from metal alkoxide has a good bonding property and a similar thermal expansion coefficient with respect to the glass package 2 and the multilayer interference film 7, which is formed of a metal oxide, and hence a reliable light emitting device may be obtained.

It should be noted that an example of forming one light emitting device 1 has been described in the above-mentioned embodiment, but a large number of the light emitting devices may be formed at the same time using a large glass substrate and the light emitting devices may be separated by scribing or dicing at the end. Further, in the above-mentioned embodiment, the steps are performed in the following order: (1) molding the glass material; (2) forming the reflective film; (3) forming the through-hole electrodes; (4) planarizing the back surface; (5) forming the back surface electrodes; (6) mounting the LED device; and (7) forming the sealing material, but the present invention is not limited to this order. For example, after the step of (3) forming the through-hole electrodes, the steps of: (6) mounting the LED device; (7) forming the sealing material; (4) planarizing the back surface; and (5) forming the back surface electrodes may be performed in the stated order.

What is claimed is:

1. A light emitting device, comprising:
a glass substrate in which a recess is formed;
a through-hole electrode formed by filling a through hole, which is formed at a bottom of the recess, with a conductive material;
a light emitting diode element received in the recess and mounted on the through-hole electrode;
an insulating reflective film formed on an inner wall surface and a bottom surface of the recess; and
a sealing material supplied to the recess to seal the light emitting diode element.

2. A light emitting device according to claim 1, wherein the reflective film is formed as a multilayer interference film.

3. A light emitting device according to claim 1, wherein the sealing material comprises a material obtained by curing one of metal alkoxide and polymetalloxane formed from metal alkoxide.

4. A light emitting device according to claim 1, wherein the through hole is formed to have a cross-sectional shape that becomes wider from a back surface of the glass substrate toward the bottom of the recess.

5. A method of manufacturing a light emitting device, comprising:
molding a glass material by a molding method to form a glass substrate having a recess and a hole in a region of the recess;
forming a reflective film, which is formed of an insulating material, on a surface of the glass substrate on which the recess is formed;
forming a through-hole electrode by providing a conductive material in the hole of the glass substrate;
grinding a back surface of the glass substrate to expose the through-hole electrode to the back surface and to planarize an exposed surface of the through-hole electrode and the back surface of the glass substrate;
mounting a light emitting diode element on the through-hole electrode exposed at a bottom of the recess of the glass substrate; and
supplying a sealing material to the recess to seal the light emitting diode element.

6. A method of manufacturing a light emitting device according to claim 5, wherein the sealing material comprises a material obtained by curing one of metal alkoxide and polymetalloxane formed from metal alkoxide.

7. A method of manufacturing a light emitting device according to claim 5, wherein the reflective film is formed as a multilayer interference film.

8. A method of manufacturing a light emitting device according to claim 5, further comprising, after the grinding, printing a metal paste on the back surface of the glass substrate to form a back surface electrode.

9. A light emitting device according to claim 2, wherein the sealing material comprises a material obtained by curing one of metal alkoxide and polymetalloxane formed from metal alkoxide.

10. A light emitting device according to claim 2, wherein the through hole is formed to have a cross-sectional shape that becomes wider from a back surface of the glass substrate toward the bottom of the recess.

11. A method of manufacturing a light emitting device according to claim 6, wherein the reflective film is formed as a multilayer interference film.

12. A method of manufacturing a light emitting device according to claim 6, further comprising, after the grinding, printing a metal paste on the back surface of the glass substrate to form a back surface electrode.
